(19) United States
(12) Patent Application Publication
(10) Pub. No.: US 2006/0179310 A1
(43) Pub. Date: Aug. 10, 2006

(54) Interactive processing method for selecting network information for a user terminal in a wireless local area network

(76) Inventor: Wenlin Zhang, Guangdong (CN)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/324,860

(22) Filed: Jan. 4, 2006

Related U.S. Application Data
(63) Continuation-in-part of application No. PCT/CN04/00738, filed on Jul. 2, 2004.

(30) Foreign Application Priority Data
Jul. 4, 2003 (CN) 03146218.9

(51) Int. Cl. H04L 9/00

(52) U.S. Cl. 713/168; 709/220; 713/171; 370/328

(57) ABSTRACT

The present invention is an interactive processing method for selecting network information for a user terminal in a WLAN. After a radio connection between a WLAN user terminal and a WLAN AN is established, the WLAN AN or the WLAN user terminal initiates an authentication procedure, and the WLAN AN sends to the WLAN user terminal a user identity request message. After receiving the user identity request message, the WLAN user terminal returns to the WLAN AN a message containing network selection information, judges whether the network selection information in the received message identifies a wireless communication network connected with the WLAN, and, if yes, sends the authentication request of the WLAN user terminal to the wireless communication network identified by the network selection information. Otherwise, the network sends an advisement message to the WLAN user terminal, and the WLAN user terminal performs subsequent operations according to the contents of the advisement. This invention enables a WLAN user terminal to select an appropriate wireless communication network according to its need when the WLAN user terminal accesses a network via a WLAN connected with a plurality of wireless communication networks.

### CROSS-REFERENCE TO RELATED APPLICATIONS

This application is a continuation-in-part of PCT Application No. PCT/CN2004/000738, filed Jul. 2, 2004, pending, which designates the U.S., which is hereby incorporated herein by reference in its entirety, and which claims priority from Chinese Application No. 03146218.9, filed Jul. 4, 2003.

### FIELD OF THE INVENTION

The present invention relates to network accessing techniques, and more particularly, to an interactive processing method for selecting network information for a user terminal in a wireless local area network (WLAN).

### BACKGROUND OF THE INVENTION

Users are demanding increasingly high rates of wireless access. WLAN can provide high-rate wireless data access in a relatively small area. The majority of WLANs use the technical standard IEEE 802.11b. This standard utilizes a 2.4 GHZ frequency band with a data transmission rate up to 11 Mbps. Other technical standards utilizing the same frequency band include IEEE 802.11g and the Bluetooth, wherein the data transmission rate of IEEE 802.11g is up to 54 Mbps. Other new standards include IEEE 802.11a and ETSI BRAN Hiperlan2, which use a 5 GHZ frequency band with a transmission rate up to 54 Mbps as well.

Although there are various standards for wireless access, most WLANs are used for transferring IP data packets. The specific WLAN access standard adopted by a wireless IP network is usually transparent to the upper-level IP. Such a network is typically configured with Access Points (AP) for implementing wireless access for a WLAN user terminal, like WLAN user equipment (UE), and with network controlling and connecting devices for implementing IP transmission.

With the rise and development of WLANs, research is focusing on the inter-workings of WLANs with various mobile communications networks, such as GSM, CDMA, WCDMA, TD-SCDMA, and CDMA2000. In accordance with the 3GPP standards, a user terminal can connect with the Internet and Intranets, as well as with home networks and visited networks of a 3GPP system via a WLAN access network (WLAN AN). As an example, for local access, a WLAN user terminal can connect to a 3GPP home network via a WLAN AN, as shown in FIG. 2. When roaming, a WLAN user terminal can connect to the 3GPP visited network via the WLAN AN. Some entities of the 3GPP visited network can be connected to corresponding entities of the 3GPP home network. For example, the 3GPP Authentication Authorization Accounting (AAA) proxy in the visited network can be connected to the 3GPP AAA server in the home network, and the WLAN Access Gateway (WAG) in the visited network can be connected to the Packet Data Gateway (PDG) in the home network, as shown in FIG. 1. FIG. 1 and FIG. 2 are schematic diagrams illustrating the networking architectures of a WLAN inter-working with a 3GPP system under roaming and non-roaming circumstances, respectively.

As shown in FIG. 1 and FIG. 2, a 3GPP system primarily includes a Home Subscriber Server (HSS)/Home Location Register (HLR), a 3GPP AAA server, a 3GPP AAA proxy, a WAG, a PDG, a Charging Gateway (CGw)/Charging information Collecting Function (CCF), and an Online Charging System (OCS). The WLAN user terminal, WLAN AN, and all of the entities of the 3GPP system together constitute a 3GPP-WLAN inter-working network, which can be regarded as a WLAN service system. In this service system, the 3GPP AAA server is in charge of authentication, authorization, and accounting of the WLAN user terminal, collecting the charging information sent from the WLAN AN and transferring the information to the charging system. The PDG is in charge of transmission of user data from the WLAN AN to the 3GPP network or other packet data networks. The charging system primarily receives and records the charging information of the WLAN user terminal transferred from the network while the OCS instructs the network to transmit online charging information periodically in accordance with the expenses of the online charged users, collects statistics and conducts control.

Under non-roaming circumstances, when a WLAN user terminal desires direct access to the Internet/Intranet, the WLAN user terminal can access the Internet/Intranet via a WLAN AN after it accomplishes an authentication step with the AAA server (AS) via the WLAN AN. If the WLAN user terminal wants to access the service of the 3GPP packet switched (PS) domain as well, it may further request the service of Scenario 3 from the 3GPP home network. That is, the WLAN user terminal can initiate a service authorization request for Scenario 3 to the AS of the 3GPP home network, which will conduct service authentication and authorization for that request. If the authentication and authorization succeeds, the AS will send an access accept message to the WLAN user terminal and assign a corresponding PDG for the WLAN user terminal. When a tunnel is established between the WLAN user terminal and the assigned PDQ the WLAN user terminal can access the service of the 3GPP PS domain. Meanwhile, the offline charging system and OCS records the charging information based on the WLAN user terminal's occupation of the network.

Under roaming circumstances, when a WLAN user terminal desires direct access to the Internet/Intranet, it may request the 3GPP home network by way of the 3GPP visited network for access to the Internet/Intranet. If the WLAN user terminal also wants to request the service of Scenario 3 to access the service of the 3GPP PS domain, the WLAN user terminal needs to initiate via the 3GPP visited network a service authorization process at the 3GPP home network. The authorization is carried out likewise between the WLAN user terminal and the AS of the 3GPP home network. After the authorization succeeds, the AS assigns the corresponding home PDG for the WLAN user terminal. In this case, the WLAN user terminal can access the service of the 3GPP PS domain of the home network after it establishes a tunnel with the assigned PDG via the WAG of the 3GPP visited network.

As shown in FIG. 3, in a 3GPP-WLAN inter-working network, if a WLAN is connected at the same time with a plurality of 3GPP visited networks, that is, a plurality of wireless communication networks (the term 3GPP visited networks as used herein refers to Visited Public Land Mobile Networks (VPLMN)) to which the WLAN AN can route the authentication signal, it can be necessary for a WLAN user terminal to select the desired VPLMN to access after the WLAN user terminal accesses the WLAN. For example, in China, a WLAN AN may be connected simultaneously with two operating VPLMN, China Mobile and China Unicom. In this case, a user of China Unicom, after getting access via the WLAN, has to instruct the WLAN AN to access the operating VPLMN of China Unicom.

As another example, a French user may roam to a WLAN in China. If the home network of the French user has roaming protocols with both China Mobile and China Unicom, when the WLAN AN is connected with both China Mobile and China Unicom, this French user needs to select a VPLMN to get access after accessing the WLAN. At present, however, there has been no specific solution for the procedure of interactive processing through which a WLAN user terminal informs the WLAN AN of the information of the network to be accessed and the 3GPP-WLAN inter-working network handles the network selection information from the WLAN user terminal.

### SUMMARY OF THE INVENTION

In view of the above, an interactive processing method for selecting network information for a WLAN user terminal in a WLAN is provided, such that the WLAN user terminal can select an appropriate wireless communication network to access according to its need when it is accessing via a WLAN connecting a plurality of wireless communication networks.

The interactive processing method for selecting network information for a user terminal in wireless local area network (WLAN) can include the following steps:

a. After a radio connection between a WLAN user terminal and a WLAN access network (AN) is established, the WLAN AN or the WLAN terminal initiates an authentication procedure and the WLAN AN sends to the WLAN user terminal a user identity request message;

b. Upon receiving the user identity request message, the WLAN user terminal returns to the WLAN AN a response message containing network selection information; and

c. The WLAN AN judges whether the network selection information in the received message indicates a wireless communication network to which the WLAN AN is able to route an authentication request. If yes, the WLAN AN sends the authentication request of the WLAN user terminal to the indicated wireless communication network. Otherwise, the WLAN AN sends an advisement message to the WLAN user terminal, and the WLAN user terminal performs subsequent operations according to the contents of the advisement message.

If the WLAN user terminal initiates the authentication procedure in step a, step a can further comprise the following step. The WLAN user terminal sends to the network side a request for information about supported wireless communication networks before the authentication procedure is initiated. The request for information about supported wireless communication networks sent by the WLAN user terminal to the network side is made by an Extendable Authentication Protocol (EAP) signaling or by the portal interaction.

Step b can further comprise the following step. Upon receiving the user identity request message, the WLAN user terminal sends to the network side a request for information about supported wireless communication networks. Upon receiving the request, the network side issues to the WLAN user terminal the information about supported wireless communication networks. The WLAN user terminal selects a wireless communication network according to the received information and re-sends to the WLAN AN an authentication request which contains the new network-selection information. The request for information about supported wireless communication networks can be a specific field placed in a response message, or a specific value of a user identity field in a response message, or an independently configured message.

In step c, the network side can send to the WLAN user terminal an advisement message containing the information about supported wireless communication networks. The method can further comprise the following steps. Upon receiving the advisement message, the WLAN user terminal re-selects a wireless communication network and obtains the network information corresponding to the selected wireless communication network based on the network information in the advisement message, sends a message containing the new network-selection information to the WLAN AN, and returns to step c. In this case, the method can further comprise the following steps. The network side waits for a response message from the WLAN user terminal after issuing the advisement message, and if the network side receives no response in a certain period of time, takes the initiative to issue a request for selection result to the WLAN user terminal. Alternatively, the network side ends the current authentication procedure after issuing the advisement message, and the WLAN user terminal, after re-selecting a wireless communication network, re-initiates to the WLAN AN an authentication procedure, and sends an authentication request which contains the new network-selection information.

In step c, if the network side sends to the WLAN user terminal an advisement message indicating the ineffectiveness of the network currently selected by the WLAN user terminal and the need for downloading the information about supported wireless communication networks, the method can further comprise the following steps. The WLAN user terminal judges whether it needs to download the information about supported wireless communication network, and if necessary, the WLAN user terminal returns to the network side a response indicating that it needs to download the network information. Upon receiving the response, the network side issues to the WLAN user terminal the information about supported wireless communication networks. Upon obtaining the information, the WLAN user terminal re-selects a wireless communication network and re-sends to the WLAN AN an authentication request which contains the new network-selection information, and returns to step c. Otherwise, the WLAN user terminal takes no additional processing steps or returns a response indicating no need for downloading the information. In this case, the method can further comprise the following steps. The network side waits for a response message from the WLAN user terminal after issuing the advisement message, and if it has not received a response after a certain period of time, takes the initiative to issue the information about supported wireless communication networks to the WLAN user terminal. Alternatively, the network side ends the current procedure after issuing the advisement message, and the WLAN user terminal, if needing the network information, takes the initiative to initiate a procedure of downloading network information.

In the above mentioned schemes, the WLAN user terminal, according to preset parameters, makes an automatic selection based on the information about supported wireless communication networks issued by the network side.

In the above mentioned schemes, if the network selection information sent by the WLAN user terminal indicates a wireless communication network to which the WLAN AN is able to route an authentication request, then step c can further comprise the following steps. The network side judges whether the network selection information includes the information about one or more visited networks, and, if yes, the WLAN AN, based on the information of the visited network, sends the authentication request to the Authentication Authorization Accounting (AAA) proxy in the visited network. Otherwise, the WLAN AN, based on the network selection information, sends the authentication request to the AAA server in the home network of the WLAN user. If the network selection information is placed in the user identity field of the response message defined in the format of Network Access Identifier (NAI), step c can further comprise the following steps. Upon receiving the authentication request of the WLAN user terminal, the AAA proxy obtains the realm name of home network by analyzing the user identity field, and forwards the authentication request to the AAA server in the home network based on the realm name of home network for authentication and authorization. The method can further comprise the following steps. Upon receiving the authentication request of the WLAN user terminal, if the AAA proxy confirms that the user identity field contains the information of visited network and the information of visited network is same as the information of the network in which the AAA proxy is located, then it modifies the user identity field so that it contains only the realm name of the home network of the WLAN user, and forwards the modified request to the home network of the WLAN user.

The operations of judging and sending an advisement message in step c can be performed by a pre-configured unit for managing and sending network information. The unit for managing and sending network information can be located in an access controller (AC), in an access point (AP) or in a local AAA server of the WLAN AN, or in an AAA functionality of a wireless communication network to which the WLAN AN is able to route the authentication request.

The network currently serving the WLAN user terminal is the home network of the WLAN user while the authentication request sent by the WLAN user terminal contains the information of visited network. The network currently serving the WLAN user terminal directly changes the information of the visited network in the authentication request into the information of the home network.

The network currently serving the WLAN user terminal is the home network of the WLAN user while the authentication request sent by the WLAN user terminal contains the information of visited network. The network currently serving the WLAN user terminal informs the WLAN user terminal that the network is the home network of the WLAN user, and judges whether the WLAN user terminal selects the home network, and, if yes, the network currently serving the WLAN user terminal authenticates the WLAN user terminal. Otherwise, the visited network authenticates the WLAN user terminal.

The method can further comprise the following step. When issuing the information about supported wireless communication networks, the network side selects and issues the information of the visited networks having roaming relationship with the home network indicated by the WLAN user terminal.

In the above mentioned schemes, the network side issues the advisement message by the EAP-Request/notification message and the advisement message contains the information about supported wireless communication networks provided for the WLAN user terminal. The WLAN user terminal comprises the WLAN User Equipment (UE).

In accordance with the interactive processing method for network selection information of a WLAN user terminal in a WLAN provided by this invention, the WLAN user terminal carries its network selection information directly in the authentication request when getting access to the WLAN. Alternatively, the WLAN makes a selection based on the information about wireless communication networks issued by the WLAN AN and sends the network selection information to the WLAN AN by the authentication request such that the WLAN AN can determine which wireless communication network this WLAN user terminal desires to access. The wireless communication network selected by the WLAN user terminal authenticates this to the WLAN user terminal. As a result, the present invention can provide a solution for interactive processing of network selection information between a WLAN user terminal and a WLAN AN when the WLAN user terminal takes the initiative in selecting a wireless communication network.

Other methods and advantages of the present invention will be or become apparent to one of ordinary skill in the art upon examination of the following drawings and detailed description. It is intended that all such additional methods and advantages be included within this description, be within the scope of the present invention, and be protected by the accompanying claims.

### BRIEF DESCRIPTION OF THE DRAWINGS

FIG. 1 is a schematic diagram illustrating the network architecture of an inter-working WLAN and 3GPP system under roaming circumstances;

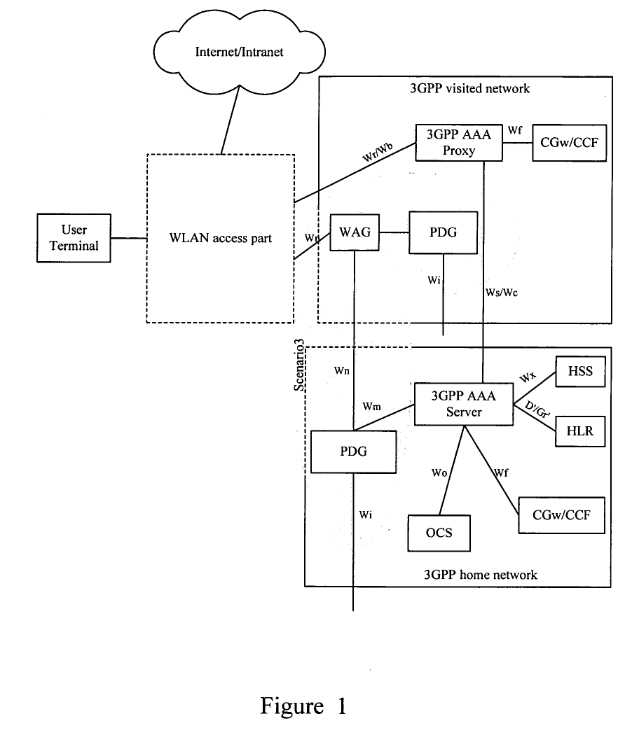

FIG. 2 is a schematic diagram illustrating the network architecture of an inter-working WLAN and 3GPP system under non-roaming circumstances;

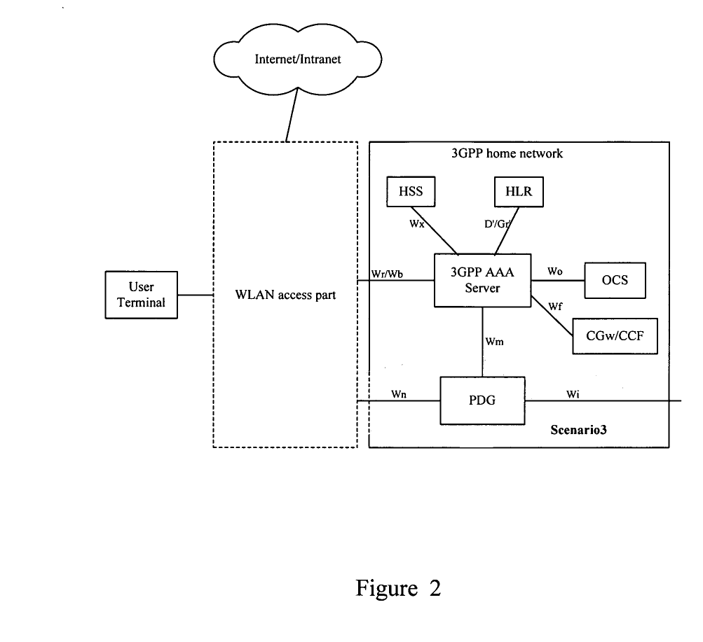

FIG. 3 is a schematic diagram illustrating the network architecture of a WLAN connecting with a plurality of visited networks;

FIG. 4 is a flowchart illustrating interactive processing of the network selection information of the WLAN user terminal in accordance with the present invention;

FIG. 5 is a flowchart illustrating authentication and authorization of a WLAN user terminal in accordance with the present invention;

FIG. 6 is a flowchart illustrating interactive processing of network selection information in accordance with a first embodiment of the present invention; and

FIG. 7 is a flowchart illustrating interactive processing of network selection information in accordance with a second embodiment of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

In accordance with the present invention, a WLAN user terminal can send the network selection information to a WLAN AN by an authentication request. The WLAN AN recognizes the wireless communication network to which this WLAN user terminal desires access based on the network selection information in the request and connects the current WLAN user terminal to the selected network for authentication and subsequent operations.

The term network selection information as used herein refers to the information of the wireless communication network to which the WLAN user terminal currently desires access and with which the WLAN is connected. This selection information may be selected in advance by the WLAN user terminal or selected by the WLAN user terminal based on the selection information of wireless communication networks issued by the network. This network selection information may be placed in an independently configured field in an authentication request or placed in the user identity field defined in the format of NAI in an authentication request.

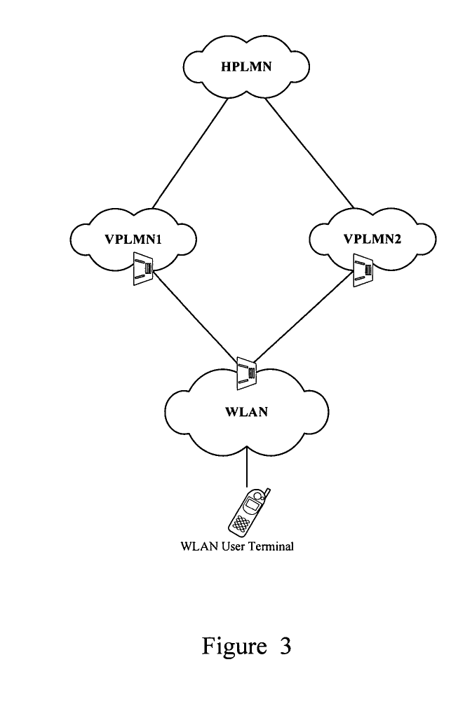

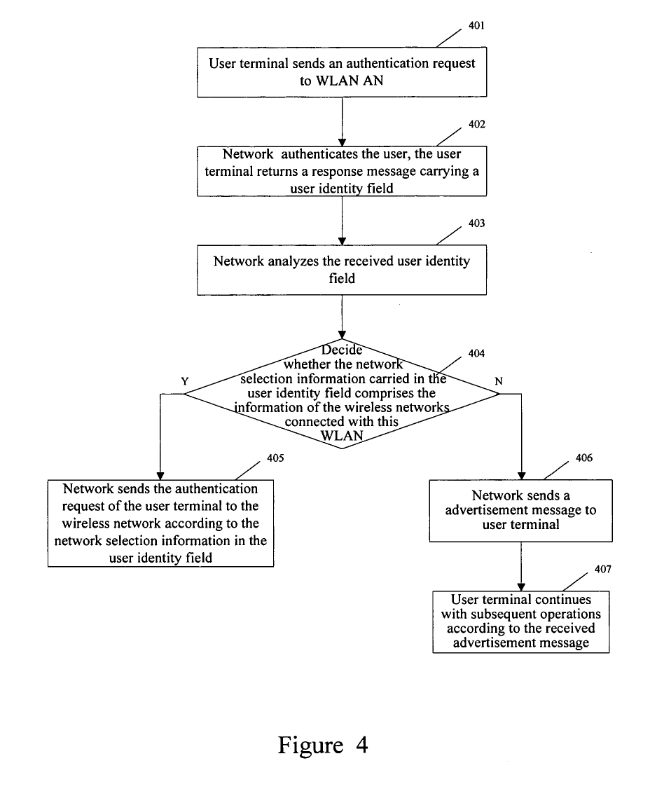

Based on the network architecture shown in FIG. 3, the interactive procedure by which the WLAN user terminal selects the information on wireless communication networks to access, as shown in FIG. 4, comprises the steps of:

Step 401: When a WLAN user terminal accesses a 3GPP-WLAN inter-working network via the WLAN, the WLAN user terminal or WLAN AN initiates an authentication procedure. Hereinafter, using the procedure initiated by the WLAN user terminal as an example, the WLAN user terminal sends an authentication request to the WLAN AN.

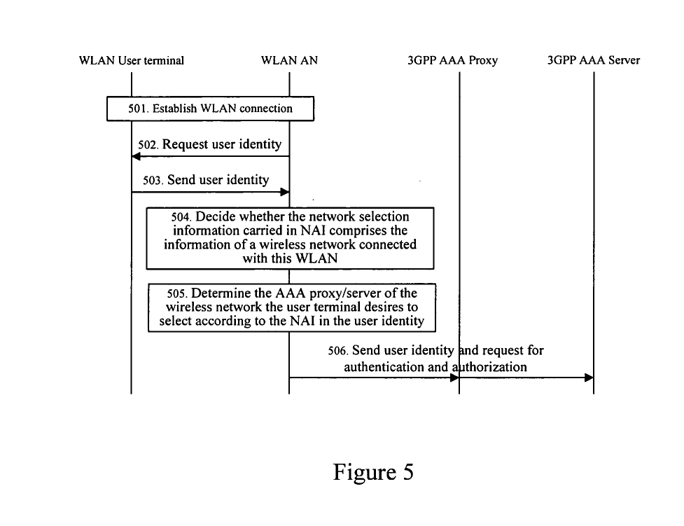

Step 402: After receiving the request, the WLAN AN starts an authentication procedure with the WLAN user terminal, i.e. an Extendable Authentication Protocol (EAP) procedure. Specifically, WLAN AN sends to the WLAN user terminal a user identity request message, requesting the username of the WLAN user terminal. After receiving this request, the WLAN user terminal sends to the WLAN AN a user identity response message containing network selection information, as shown in steps 502 and 503 in FIG. 5. This network selection information may be placed in the user identity field defined in the format of NAI. Using the network selection information placed in the user identity field as an example hereinafter, the user identity field comprises two portions, the username portion and the realm name portion.

Steps 403˜404: After receiving the response message carrying network selection information, the WLAN AN analyses the user identity field in the response message and decides whether the network selection information carried in the user identity field is the information of an wireless communication network connected with the WLAN. If yes, the WLAN AN performs step 405. Otherwise, i.e., the WLAN AN cannot recognize the wireless communication network in the network selection information, the WLAN AN performs step 406.

Step 405: The WLAN AN determines the wireless communication network to which the WLAN user terminal desires to access based on the network selection information in the user identity field NAI, and the WLAN AN sends the authentication request of the WLAN user terminal to the wireless communication network identified by the network selection information for authentication.

If the WLAN AN decides based on the network selection information carried in the user identity field that the information includes information of a visited network, the WLAN AN sends the authentication request to the AAA proxy of the visited network currently serving this WLAN user terminal based on the information of the visited network in the user identity field. The AAA proxy will forward the authentication request to the AAA server of the home network of the WLAN user terminal for authentication. Otherwise, the WLAN AN will send the authentication request to the AAA server of the home network of the WLAN user terminal based on the network selection information in the user identity field for authentication, as shown in step 506 in FIG. 5. If the AAA proxy of the visited network, after receiving the authentication request of the WLAN user terminal, decides that the user identity field contains information of the visited network and the information of the visited network is the information of this network, then the AAA Proxy modifies the realm name portion in the user identity field so that the field contains only the realm name of the home network, and then sends the modified request to the home network of the WLAN user terminal.

If the network currently serving the WLAN user terminal is directly connected with the home network of the WLAN user terminal but the WLAN user terminal initiates the authentication request by an identifier of roaming network, i.e., the network selection information carried in the request contains information of a visited network, then the network currently serving the WLAN user terminal may directly modify the information of the visited network in the user identity field NAI into the information of home network. Alternatively, the network currently serving the WLAN user terminal may send an advisement message to the WLAN user terminal to inform the user that the network currently serving the WLAN user terminal is its home network. If the WLAN user terminal re-initiates an authentication request with the information of the home network, the network currently serving the WLAN user terminal will directly perform the authentication procedure. However, if the WLAN user terminal still confirms that the roaming network is selected, the network currently serving the WLAN user terminal will authenticate to this WLAN user terminal and provide subsequent services by the roaming network.

Steps 406˜407: The network side sends an advisement message to the WLAN user terminal, and the WLAN user terminal continues with subsequent operations based on the contents of the advisement message. The advisement message may directly adopt the EAP-Request/Notification message in the WLAN protocol, or adopt an independently configured advisement message. The advisement message sent to WLAN user terminal by the network can be classified into two types. One type is an advisement message that directly contains the information of wireless communication networks issued by the network such that a WLAN user terminal or user could make a direct selection. The other advisement message informs the WLAN user terminal that the information of the selected wireless communication network is ineffective and that the WLAN user terminal needs to download the information of the wireless communication networks.

In connection with the first type, since the advisement message includes the information of the wireless communication networks connected with the WLAN, the WLAN user terminal can re-select a wireless communication network after receiving the message, obtain the network information corresponding to the selected wireless communication network based on the network information in the advisement message, place the information of the selected wireless communication network in the user identity field NAI of the response message, and send the message to the WLAN AN again for recognition, and then return to step 403. Here, the network may wait for the response of selection from the WLAN user terminal after issuing the advisement message, and after waiting for certain time, if having not received a response, the network may take the initiative to send a selection result request to WLAN user terminal. The network may also end the current procedure after issuing the advisement message without waiting for the selection response from the WLAN user terminal. In this case, the WLAN user terminal may re-initiate an authentication procedure for the second time.

In connection with the second type of advisement message, after receiving the advisement message, the WLAN user terminal will automatically choose or the user will choose whether to download the information about the wireless communication networks. If the WLAN user terminal will automatically make a choice, the WLAN user terminal can handle the information issued from the network automatically according to parameters set in advance by the user and select an appropriate wireless communication network automatically. If the user makes a choice, when necessary, the information can be displayed for the user to make a choice, and when the information is displayed to the user, the WLAN user terminal may decide to choose to display the information about the networks having roaming relationship with the user's home network. If necessary to download the information, the WLAN user terminal will return to the network a response indicating the need to download the network information. After receiving this response, the network will issue to the WLAN user terminal the information about the wireless communication networks. After obtaining the information about the wireless communication networks, the WLAN user terminal will re-select a wireless communication network and re-initiate an authentication request carrying the new network-selection information, then return to step 403. If it is unnecessary to download the network information, the WLAN user terminal will not conduct additional processing operations or will return a response message indicating that it is not necessary to download the information. Here, the network may wait for the response about selection from the WLAN user terminal after issuing the advisement message, and after waiting for certain time, if a response is not received, the network will take the initiative to issue the information about the wireless communication networks to the WLAN user terminal. The network may also end the current procedure after issuing the advisement message without waiting for the selection response from the WLAN user terminal. In this case, if the WLAN user terminal needs to download network information, the WLAN user terminal may take the initiative to send a request to initiate a network information downloading procedure.

In the above two cases, the information about the wireless communication network provided by the network for the WLAN user terminal to make a selection is stored in a special network information storing unit. This information usually includes the following parameters: network name, bearing capacity of network, QoS, bandwidth, service capacity, available WLAN inter-working scenarios, charging rates, categories of service provider, etc. When issuing the information about the wireless communication networks connected with the current WLAN, the network may choose to issue the information about the visited networks having roaming relationship with the home network indicated by the WLAN user terminal. If there is no such a visited network, the network may issue no information or inform the user that no roaming relationship exists.

In the above solution, recognizing the network selection information in step 404 and sending the advisement message in step 406 may be conducted by one network authentication entity, which may be referred to as the unit for managing and sending network information. Such a unit may exist in the WLAN AN, e.g., configured in the Access Controller (AC); or may exist in an wireless communication network which is connected to the current WLAN AN but located outside the WLAN AN and provide service for a plurality of WLAN ANs, e.g., configured in an AAA server; or may be a default AAA proxy configured in advance.

In the above solution, if the WLAN user terminal initiates an authentication procedure but cannot determine the wireless communication network to be selected at the time of authentication, then the WLAN user terminal may send to the network a request for downloading the information about the wireless communication networks connected with the current WLAN before or at the same time as sending the authentication request or during the authentication procedure, i.e. the WLAN user terminal may obtain the information about the wireless communication networks and select a network before initiating an authentication procedure; or the network information downloading procedure is performed parallel with the authentication procedure. Here, the WLAN user terminal may send to the network the request for downloading network information by EAP signaling or by Portal interaction. The WLAN user terminal may also send to the network a request to download the information about the wireless communication networks connected with the current WLAN after receiving the user identity request message sent from the WLAN AN. Such a request from the WLAN user terminal may be sent as an independent signal; or a request identifier may be placed in the user identity response message, e.g. username in the response is null while the pre-configured download request field is set, or it may directly be defined that the username 0xFFFF in the response message represents the need of downloading network information.

### Embodiment 1

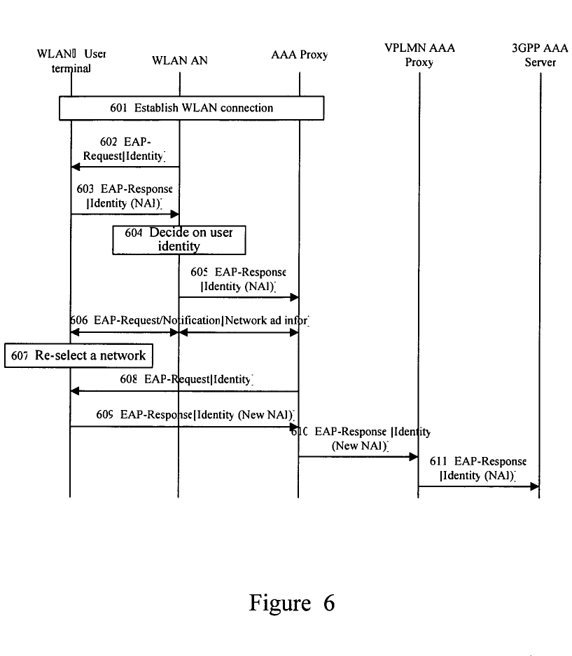

In this embodiment, a default AAA proxy is configured in advance in a 3GPP-WLAN inter-working network as the unit for managing and sending network information. This unit may provide service for one or more than one WLAN AN. As shown in FIG. 6, the procedure of interactive processing of network selection information in accordance with this invention comprises the steps of:

Steps 601˜603: After a WLAN user terminal sets up a radio connection with the WLAN AN, the WLAN user terminal sends an authentication request to the WLAN AN. After receiving the request, the WLAN AN sends to the WLAN user terminal an EAPoL-Request[Identity] message. After receiving the message, the WLAN user terminal sends to the WLAN AN an EAPoL-Response[Identity] message carrying a user identity field in NAI format, and this user identity field carries the network selection information.

Steps 604˜605: The WLAN AN, based on the user identity field in the received message, determines the sending route of the authentication request of the WLAN user terminal. If finding the user identity field unrecognizable, i.e., the network identified is not any of the wireless communication networks connected with the WLAN, the WLAN AN will route this authentication request to the default AAA proxy.

Step 606: After receiving the authentication request, if the default AAA proxy finds that the network selection information therein matches no wireless communication network connected with this WLAN, it then sends an advisement message of EAP-Request/Notification to the WLAN AN. The WLAN AN then sends the advisement message down to the WLAN user terminal. In accordance with EAP, both the WLAN AN and the user will immediately respond for acknowledgement after receiving the message. The advisement message carries the information about the wireless communication networks connected with this WLAN. One or more than one message may be sent. The interaction is ended according to the instruction information in the last EAP message.

Step 607: The WLAN user terminal re-selects a network after receiving the information about wireless communication networks carried in the advisement message. Here, the AAA proxy and WLAN AN will wait for the response from the WLAN user terminal after the advisement message is sent down.

Steps 608˜609: The AAA proxy sends an EAP-Request[Identity] message again to the WLAN user terminal to request the user identity. After receiving the message, the WLAN user terminal returns the user identity carrying the new network-selection information by an EAPoL-Response[Identity] message.

Steps 610˜611: The WLAN AN, according to the new network-selection information sent from the WLAN user terminal, determines the wireless communication network the WLAN user terminal desires to access, i.e., a VPLMN here, and sends the information about the authentication request to the AAA proxy and AS in the identified VPLMN for authentication.

### Embodiment 2

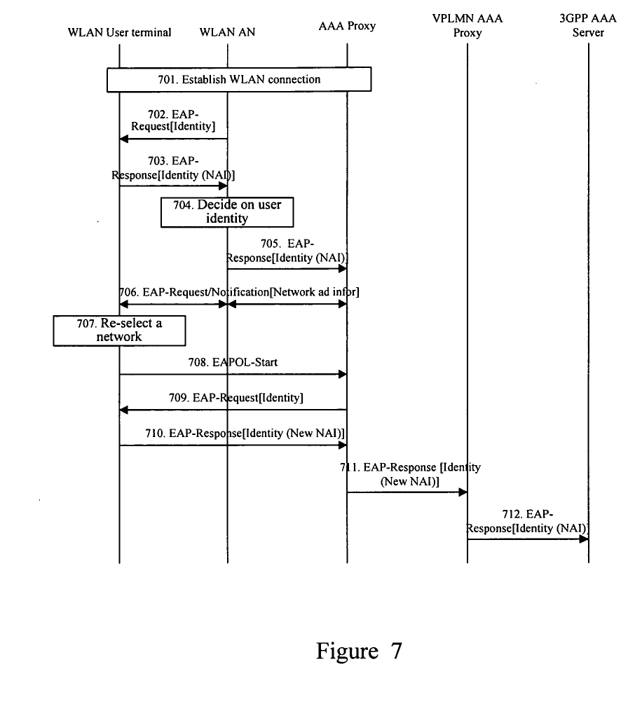

In this embodiment, a default AAA proxy is configured in advance in a 3GPP-WLAN inter-working network as the unit for managing and sending network information. This unit may provide service for one or more than one WLAN AN. As shown in FIG. 7, the procedure of interactive processing of network selection information in accordance with this invention comprises the steps of:

Steps 701˜707 are substantially the same as steps 601˜607 in the first embodiment except that, after the advisement message is sent, the AAA proxy and the WLAN AN will not wait for the response from the WLAN user terminal but directly end the relevant procedures.

Step 708: Because the AAA proxy and the WLAN AN will not wait for the response from the WLAN user terminal, the WLAN user terminal, after re-selecting a network based on the information about the wireless communication networks in the advisement message, re-initiates an authentication procedure by an EAPOL-Start message.

Steps 709˜710: After receiving the EAPOL-Start message, the WLAN AN re-sends an EAP-Request[Identity] message to the WLAN user terminal to request the user identity again. The WLAN user terminal returns the user identity carrying the new network-selection information to the WLAN AN by an EAPoL-Response[Identity] message.

Steps 711˜712: After receiving the new user identity, the WLAN AN, based on the new network-selection information therein, determines the wireless communication network selected by the WLAN user terminal, and sends the information about the authentication request by the WLAN user terminal to the AAA proxy and AS of the network identified by the network selection information for authentication. Here, after receiving the information about the authentication request, the roaming network selected by the WLAN user terminal will first modify the information of the visited network in the user identity field into the information of the home network of this WLAN user terminal, and then send the information about the authentication request carrying the modified user identity field to the AS of the home network of this WLAN user terminal for authentication.

The foregoing description is directed to exemplary embodiments of this invention and should not be construed as limiting the protection scope thereof. Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

1. An interactive processing method for selecting network information for a user terminal in a wireless local area network (WLAN), comprising:
a. initiating via a WLAN access network (AN) or a WLAN user terminal an authentication procedure after establishing a radio connection between the WLAN user terminal and the WLAN AN and sending to the WLAN user terminal via the WLAN AN a user identity request message;
b. returning via the WLAN user terminal to the WLAN AN a response message containing network selection information after receiving the user identity request message; and
c. determining whether the network selection information in the received message indicates a wireless communication network to which the WLAN AN is able to route an authentication request, and, if yes, sending the authentication request of the WLAN user terminal to the indicated wireless communication network; otherwise, sending an advisement message to the WLAN user terminal so that the WLAN user terminal can perform subsequent operations according to the contents of the advisement message.

2. The method according to claim 1, wherein if the WLAN user terminal initiates the authentication procedure in step a, step a further comprises sending via the WLAN user terminal to the network side a request for information about supported wireless communication networks before the authentication procedure is initiated.

3. The method according to claim 2, wherein the request for information about supported wireless communication networks sent by the WLAN user terminal to the network side is made by an Extendable Authentication Protocol (EAP) signal or by the portal interaction.

4. The method according to claim 1, wherein step b further comprises: upon receiving the user identity request message, sending via the WLAN user terminal to the network side a request for information about supported wireless communication networks; upon receiving the request, issuing by the network side to the WLAN user terminal the information about supported wireless communication networks; selecting by the WLAN user terminal a wireless communication network based on information received and re-sending to the WLAN AN an authentication request which contains the new network-selection information.

5. The method according to claim 4, wherein the request for information about supported wireless communication networks is a specific field placed in a response message, or a specific value of a user identity field in a response message, or an independently configured message.

6. The method according to claim 1, wherein step c further comprises sending via the network side to the WLAN user terminal an advisement message containing the information about supported wireless communication networks, and wherein the method further comprises re-selecting by the WLAN user terminal a wireless communication network after receiving the advisement message and obtaining the network information corresponding to the selected wireless communication network based on the network information in the advertisement message, sending a message containing the new network-selection information to the WLAN AN, and returning to step c.

7. The method according to claim 6, further comprising: waiting by the network side for a response message from the WLAN user terminal after issuing the advisement message, and if no response is received within a certain period of time, initiating a request for selection result to the WLAN user terminal.

8. The method according to claim 6, further comprising: ending by the network side the current authentication procedure after issuing the advisement message, and after re-selecting a wireless communication network, re-initiating an authentication procedure and sending an authentication request which contains the new network-selection information by the WLAN user terminal to the WLAN AN.

9. The method according to claim 1, wherein step c further comprises sending by the network side to the WLAN user terminal an advisement message indicating the ineffectiveness of the network currently selected by the WLAN user terminal and the need for downloading information about supported wireless communication networks, and wherein the method further comprises:
determining by the WLAN user terminal whether it needs to download information about supported wireless communication networks,
returning by the WLAN user terminal as necessary to the network side a response indicating that it needs to download the network information;
upon receiving the response, issuing by the network side information to the WLAN user terminal the information about supported wireless communication networks; and
after obtaining the information, re-selecting by the WLAN user terminal a wireless communication network and re-sending to the WLAN AN an authentication request which contains the new network-selection information, and returning to step c; otherwise, not processing additional steps or returning a response indicating no need for downloading the information.

10. The method according to claim 9, further comprising: waiting by the network side for a response message from the WLAN user terminal after issuing the advisement message, and if having not received a response after a certain period of time, issuing the information about supported wireless communication networks to the WLAN user terminal.

11. The method according to claim 9, further comprising ending by the network side the current procedure after issuing the advisement message, and downloading network information by the WLAN user terminal, if needing network information.

12. The method according to claim 6, wherein the WLAN user terminal, based on preset parameters, makes an automatic selection based on the information about supported wireless communication networks issued by the network side.

13. The method according to claim 9, wherein the WLAN user terminal, based on preset parameters, makes an automatic selection based on the information about supported wireless communication networks issued by the network side.

14. The method according to claim 1, wherein when the network selection information sent by the WLAN user terminal indicates a wireless communication network to which the WLAN AN is able to route an authentication request, step c further comprises: determining by the network side whether the network selection information includes information about one or more visited networks, and if yes, sending by the WLAN AN, based on the information of the visited network, the authentication request to the Authentication Authorization Accounting (AAA) proxy in the visited network; otherwise, sending by the WLAN AN, based on the network selection information, the authentication request to the AAA server in the home network of the WLAN user.

15. The method according to claim 1, wherein the network selection information is placed in the user identity field of the response message defined in the format of Network Access Identifier (NAI).

16. The method according to claim 14, wherein the network selection information is placed in the user identity field of the response message defined in the format of Network Access Identifier (NAI), and step c further comprises: upon receiving the authentication request of the WLAN user terminal, obtaining by the AAA proxy the realm name of the home network by analyzing the user identity field, and forwarding the authentication request to the AAA server in the home network based on the realm name of the home network for authentication and authorization.

17. The method according to claim 16, further comprising: upon receiving the authentication request of the WLAN user terminal, if the AAA proxy confirms that the user identity field contains the information of the visited network and the information of the visited network is the same as the information of the network in which the AAA proxy is located, modifying the user identity field to contain only the realm name of the home network of the WLAN user, and forwarding the modified request to the home network of the WLAN user.

18. The method according to claim 1, wherein the operations of determining and sending an advisement message in step c are performed by a pre-configured unit for managing and sending network information.

19. The method according to claim 18, wherein the unit for managing and sending network information is located in an access controller (AC), or in an access point (AP) or in a local AAA server of the WLAN AN, or in an AAA functionality of a wireless communication network to which the WLAN AN is able to route the authentication request.

20. The method according to claim 1, wherein the network currently serving the WLAN user terminal is the home network of the WLAN user while the authentication request sent by the WLAN user terminal contains the information of visited network, the method further comprising directly changing by the network currently serving the WLAN user terminal the information of the visited network in the authentication request into the information of the home network.

21. The method according to claim 1, wherein the network currently serving the WLAN user terminal is the home network of the WLAN user while the authentication request sent by the WLAN user terminal contains the information of visited network, wherein the method further comprises informing by the network currently serving the WLAN user terminal the WLAN user terminal that the network is the home network of the WLAN user, determining whether the WLAN user terminal selects the home network, and if yes, authenticating by the network currently serving the WLAN user terminal the WLAN user terminal; otherwise, authenticating by the visited network the WLAN user terminal.

22. The method according to claim 4, further comprising: when issuing the information about supported wireless communication networks, selecting and issuing by the network side the information of the visited networks having roaming relationship with the home network indicated by the WLAN user terminal.

23. The method according to claim 6, further comprising: when issuing the information about supported wireless communication networks, selecting and issuing by the network side the information of the visited networks having roaming relationship with the home network indicated by the WLAN user terminal.

24. The method according to claim 9, further comprising: when issuing the information about supported wireless communication networks, selecting and issuing by the network side the information of the visited networks having roaming relationship with the home network indicated by the WLAN user terminal.

25. The method according to claim 6, wherein the network side issues the advisement message by the EAP-Request/notification message and the advisement message contains the information about supported wireless communication networks provided for the WLAN user terminal.

26. The method according to claim 9, wherein the network side issues the advisement message by the EAP-Request/notification message and the advisement message contains the information about supported wireless communication networks provided for the WLAN user terminal.
